(19) United States
(12) Patent Application Publication
(10) Pub. No.: US 2010/0002145 A1
(43) Pub. Date: Jan. 7, 2010

(54) ADAPTIVE OPTIMIZATION OF A VIDEO SIGNAL

(76) Inventors: John P. Spence, Webster, NY (US); William V. Fintel, Rochester, NY (US); Thomas E. Madden, Fairport, NY (US); Esther M. Betancourt, Rochester, NY (US); John T. Keech, Penfield, NY (US)

Correspondence Address: Raymond L. Owens;Patent Legal Staff, Eastman Kodak Company, 343 State Street, Rochester, NY, 14650-2201, US

(21) Appl. No.: 12/495,833

(22) Filed: Jul. 1, 2009

Related U.S. Application Data
(60) Provisional application No. 61/078,641, filed on Jul. 7, 2008.

(51) Int. Cl. H04N 5/14

(52) U.S. Cl. 348/576; 348/E05.062

(57) ABSTRACT

A video signal includes a plurality of frames of image data. A single frame of image data or multiple frames of image data, one or more reduced resolution frames, or a portion or portions of one or more frames or reduced resolution frames can be analyzed to determine initial statistics. One or more correction operations are then performed on the initial statistics to generate initial correction values. The one or more correction operations include a balance correction operation, a flare correction operation, and a tonal correction operation. After the initial correction values are determined, a temporal filter is applied to the initial correction values to generate final correction values. Optimized image data is then generated by applying the final correction values to image data in one or more frames.

### CROSS REFERENCE TO RELATED APPLICATIONS

This application claims the benefit of U.S. Provisional Application 61/078,641 filed on Jul. 7, 2008, which is hereby incorporated by reference.

### TECHNICAL FIELD

The present invention relates generally to video signals, and more particularly to methods for adaptively optimizing video signals.

### BACKGROUND

The dynamic range of a scene or an image is the ratio of its maximum luminance to its minimum luminance. Similarly, the dynamic range of a visual display, such as a color LCD or CRT monitor, is the ratio of the maximum luminance to the minimum luminance that is rendered on the display medium. In conventional optical printing of reflection images, when a scene has a larger dynamic range than can be rendered on a reflection output medium, there will be a loss of detail in the rendering process, especially in the highlight or shadow areas.

This loss of detail is also a problem when the output medium is a visual display device, such as, for example, a cathode-ray tube (CRT) display, a liquid crystal display (LCD), an organic light emitting diode (OLED) display, a plasma display panel (PDP), and a projection display. This is because the display devices typically have a smaller dynamic range compared to the captured image. The captured image can take the form of still images, video images, computer-generated images, or any combination thereof. This loss in detail may be created during the image-capture process, image-generation process, image-storage process, image-editing process, image-transmission process, image-encoding process, image-decoding process, or image-display process.

Digital image processing can be used to preserve image detail by compressing the input dynamic range, or by correcting for defects in the underlying tone scale. The simplest of these algorithms creates static corrections that are independent of image content or independent of level of image detail loss. More complex algorithms perform various levels of image analysis, and the corrections are adjusted for the amount and characteristic of image loss in each image.

U.S. Pat. No. 6,717,698 discloses a method to calculate an image-dependent tone scale curve, while U.S. Pat. No. 7,158,686 discloses a method to calculate an image-dependent tone scale curve. These algorithms can improve highlight detail, shadow detail, and overall image darkness or lightness. Unfortunately, in some situations, these techniques may not adequately correct for dynamic variations in black levels that can be incurred due to poor image-capture techniques, image-encoding techniques, image-transmission techniques, or poor image editing techniques. Also, the method in U.S. Pat. No. 7,158,686 may require substantial image processing calculation capability.

In U.S. Pat. No. 6,912,321, a method is provided to calculate an image-dependent correction for flare light. This method can correct for variations in black levels that can be incurred due to poor image editing techniques. Unfortunately, in some situations, this technique may not adequately correct for shadow and highlight detail loss. It may also not adequately correct for overall darkness or lightness problems in the image.

In addition to the problems with the algorithms cited above, these algorithms were designed primarily for single still-image applications. If one or more of these algorithms are used with multiple images, such as in a video stream of images, there can be erratic behavior in the correction results causing abrupt changes to scene lightness, highlight detail or shadow detail.

### SUMMARY

A method or methods for determining correction values for a video signal that includes a plurality of frames of image data optimizing a video signal that includes a plurality of frames of image data first determines correction values for one or more frames. At least a portion of one or more frames of image data, or at least a portion of one or more reduced resolution frames of image is data are analyzed to generate initial statistics. One or more correction operations are then performed on the initial statistics to generate initial correction values. After the initial correction values are determined, a temporal filter is applied to the initial correction values to generate final correction values. Optimzed image data is then generated by applying the final correction values to image data in one or more frames.

The one or more correction operations include a balance correction operation, a flare correction operation, and a tonal correction operation. The balance operation corrects for any neutral errors or color balance errors in the frame of image data in an embodiment in accordance with the invention. The flare correction operation corrects for any veiling flare type of artifacts in the frame of image data in an embodiment in accordance with the invention. And the tonal correction operation corrects for any tonal defects in the frame of image data in an embodiment in accordance with the invention.

A computer readable medium can have stored therein instructions to execute the method or methods for determining correction values described herein.

### ADVANTAGEOUS EFFECT

The present invention provides a method or methods for optimizing video signals. The methods can correct for balance errors, flare artifacts, and tonal defects in an image or a portion or portions of an image, either separately or in various combinations.

### BRIEF DESCRIPTION OF THE DRAWINGS

FIG. 1 is a simplified block diagram of a display system in an embodiment in accordance with the invention;

FIG. 2 is a flowchart depicting a method for processing video signal in the display system 100 of FIG. 1 in an embodiment in accordance with the invention;

FIG. 3 is a simplified block diagram of an image capture device in an embodiment in accordance with the invention;

FIG. 4 is a flowchart depicting a method for processing a video signal in the image capture device 102 of FIG. 1 in an embodiment in accordance with the invention;

FIG. 5 is a flowchart illustrating a method for optimizing a video signal in an embodiment in accordance with the invention;

FIG. 6 is a flowchart depicting a method for determining balance corrections in an embodiment in accordance with the invention;

FIG. 7 is a flowchart illustrating a method for performing flare correction in an embodiment in accordance with the invention;

FIG. 8 is a flowchart depicting a method for performing tonal correction on selected frames of image data in an embodiment in accordance with the invention; and

FIG. 9 is a flowchart illustrating a method for determining the initial correction results in an embodiment in accordance with the invention.

### DETAILED DESCRIPTION

Throughout the specification and claims, the following terms take the meanings explicitly associated herein, unless the context clearly dictates otherwise. The meaning of “a,” “an,” and “the” includes plural reference, the meaning of “in” includes “in” and “on.” The term “connected” means either a direct electrical connection between the items connected or an indirect connection through one or more passive or active intermediary devices. The term “circuit” and “device” means either a single component or a multiplicity of components, either active or passive, which are connected together to provide a desired function. The term “signal” means at least one current, voltage, or data signal. References to flare corrections apply to image content affected by various video processing or video capture calibration problems that are unrelated to optical flare phenomena. Referring to the drawings, like numbers indicate like parts throughout the views.

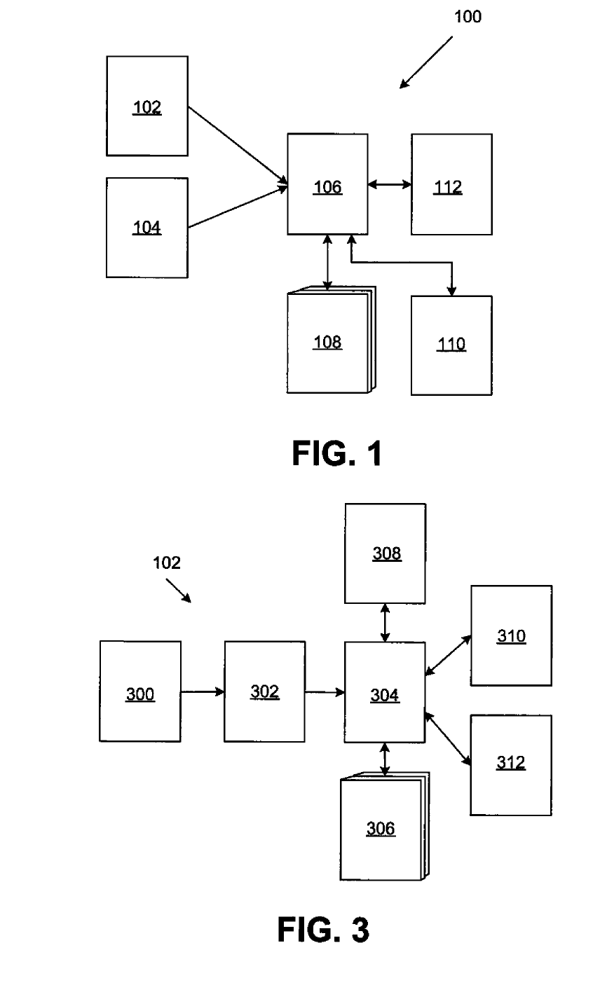

Referring now to FIG. 1, there is shown a simplified block diagram of a display system in an embodiment in accordance with the invention. Display system 100 includes image capture device 102, one or more other types of input devices 104, and processor 106. Processor 106 is configured, for example, as a microprocessor, a central processing unit (CPU), an application-specific integrated circuit (ASIC), a Field Programmable Gate Array (FPGA), a digital signal processor (DSP), or other processing device, or combinations of multiple such devices, in one or more embodiments in accordance with the invention.

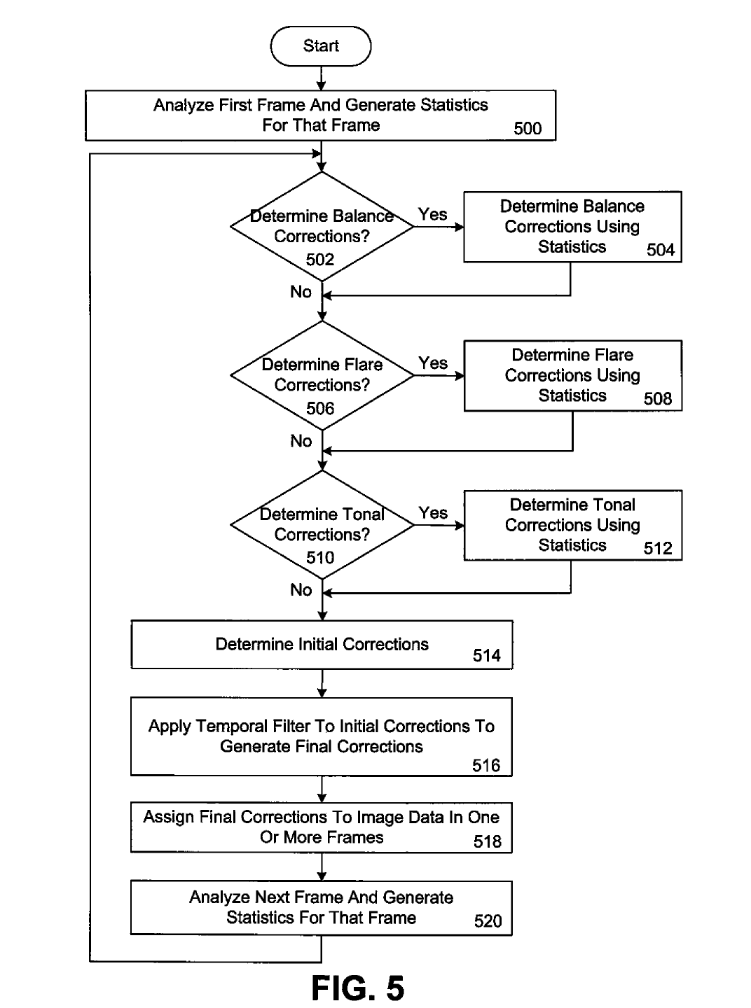

Processor 106 may store a video signal in memory 108. The video signal includes any video signal, including, but not limited to, 1080p, 1080i, 720p, 480p, 480i, NTSC, PAL, SECAM, VGA, and QVGA video signals. Memory 108 is implemented as any type of memory, such as, for example, random access memory (RAM), DRAM, SDRAM, flash memory, disk-based memory, removable memory, or other types of storage elements, in any combination, in an embodiment in accordance with the invention. Communications port 110 is an input/output port for communicating with other devices and networks, such as, for example, various on-screen controls, buttons or other user interfaces, network interfaces, and remote or voice control interfaces. And finally, display 112 is used to display the video signal. Display 112 is configured as a cathode-ray tube (CRT) display, a liquid crystal display (LCD), an organic light emitting diode (OLED) display, a plasma display panel (PDP), a projection display, or other display technology in one or more embodiments in accordance with the invention. When display system 100 performs the methods shown in FIGS. 5-9, or the methods of FIGS. 5-9 are performed by image capture device 102, or by processor 106, display 112 will display optimized a video signal.

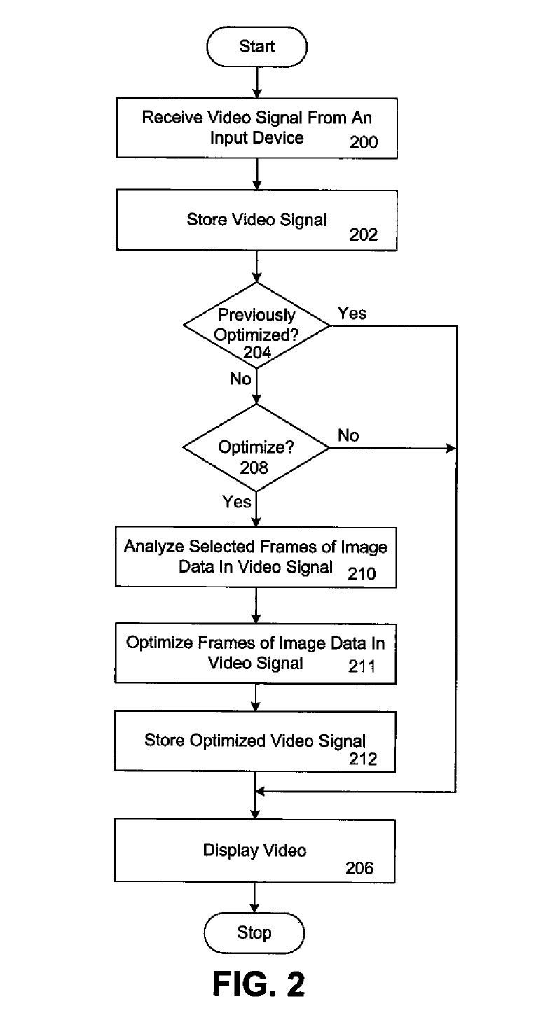

FIG. 2 is a flowchart depicting a method for processing video signal in the display system 100 of FIG. 1 in an embodiment in accordance with the invention. Initially, the display system receives a video signal from an input device, as shown in block 200. Examples of various input devices include, but are not limited to, an image capture device, a DVD, a CD, a hard drive, other storage device, an antenna, a cable set-top box, a computing device, and a network or website source.

The video signal is optionally stored in a memory, as shown in block 202. A determination is then made at block 204 as to whether the video signal has been previously optimized by an image capture device or some other computing device and optionally stored in a storage medium, such as a hard drive, DVD, or removable memory. If the video signal has been optimized, the method passes to block 206 where the optimized video is displayed.

If the video signal has not been optimized, a determination is made at block 208 as to whether or not the video signal is to be optimized. For example, a user may decide he or she does not want to optimize the video signal. Alternatively, the image characteristics of the video signal may be such that optimization is not necessary. If the video signal will not be optimized, the method passes to block 206 where the non-optimized video is displayed.

If the video signal is to be optimized, selected frames of image data in the video signal are analyzed (block 210) and the results of the analysis used to optimize one or more frames (block 211). The one or more frames can include the currently analyzed frame and/or previous and/or subsequent frames. The optimized video is optionally stored in memory at block 212. A method for optimizing frames of image data is described in more detail in conjunction with FIGS. 5-9.

Embodiments in accordance with the invention are not limited to the method shown in FIG. 2. Other embodiments may implement additional or alternate steps, or not perform one or more of the steps shown in FIG. 2. By way of example only, block 202, block 204, or both blocks 202 and 204 may not be performed in display systems that optimize the selected frames of image data in real-time. At block 204, if the image has been previously optimized, the user may elect to re-optimize the image using the method described in more detail in conjunction with FIGS. 5-9.

Referring now to FIG. 3, there is shown a simplified block diagram of an image capture device in an embodiment in accordance with the invention. In image capture device 102, light from a subject scene is input to an imaging stage 300. Imaging stage 300 may comprise conventional elements such as a lens, a neutral density filter, an iris and a shutter. The light is focused by imaging stage 300 to form an image on image sensor 302, which converts the incident light to electrical signals. Image sensor 302 is implemented as a Charge-Coupled Device (CCD) image sensor or a Complementary Metal Oxide Semiconductor (CMOS) image sensor in an embodiment in accordance with the invention. Image sensor 302 may also consist of light capture by a photographic element, followed by photographic processing, and finally a scanning step. Other types of image sensors or light capture technology may be used in other embodiments in accordance with the invention.

Image capture device 102 further includes processor 304, memory 306, display 308, output device 310, and communication port 312. Processor 304 is configured, for example, as a microprocessor, a central processing unit (CPU), an application-specific integrated circuit (ASIC), a Field Programmable Gate Array (FPGA), a digital signal processor (DSP), or other processing device, or combinations of multiple such devices, in one or more embodiments in accordance with the invention. Memory 306 is implemented as any type of memory, such as, for example, random access memory (RAM), DRAM, SDRAM, flash memory, removable memory, or other types of storage elements, in any combination, in an embodiment in accordance with the invention.

Output device 310 is implemented as one or more types of output devices, including, but not limited to, a DVD, CD, flash drive, and a hard drive. Communications port 312 is an input/output port for communicating with other devices and networks, such as, for example, various on-screen controls, buttons or other user interfaces, network interfaces, and remote or voice control interfaces. And finally, display 308 is configured as a liquid crystal display (LCD), an organic light emitting diode (OLED) display, or other display technology in one or more embodiments in accordance with the invention. When image capture device 102 performs the methods shown in FIGS. 5-9, or a display system, such as display system 100, performs the methods in FIGS. 5-9, an optimized video signal will be shown on a display or sent to an output device.

It is to be appreciated that display system 100 and image capture device 102, as shown in FIGS. 1 and 3, respectively, may include additional or alternative elements of a type known to those skilled in the art. Elements not specifically shown or described herein may be selected from those known in the art. The present invention may be implemented in a wide variety of display systems and image capture devices. For instance, the inventions described herein could be applied to such systems as digital televisions, television broadcast systems, kiosk fulfillment systems, personal computers, etc. Also, certain aspects of the embodiments described herein may be implemented at least in part in the form of software executed by one or more processing elements of a display system. Such software can be implemented in a straightforward manner given the teachings provided herein, as will be appreciated by those skilled in the art.

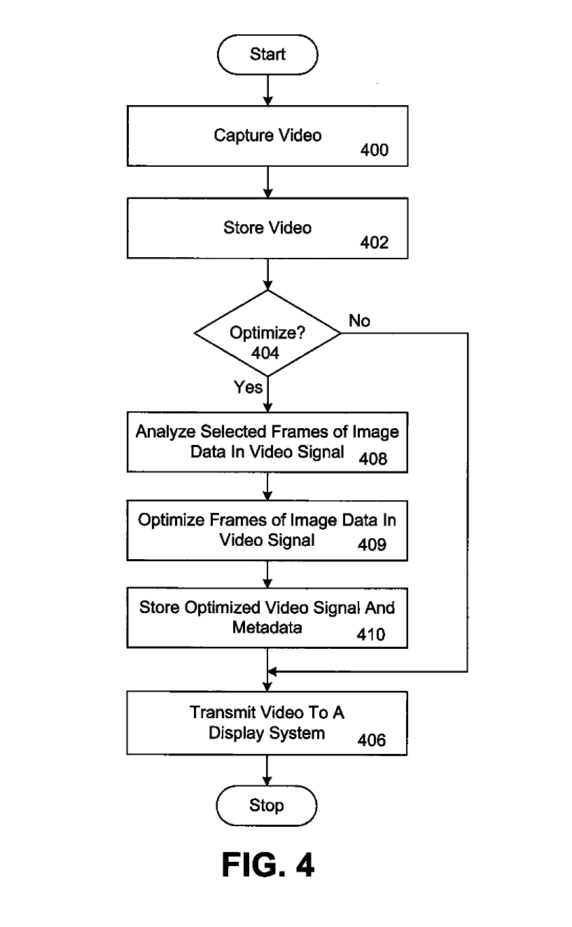

FIG. 4 is a flowchart depicting a method for processing a video signal in the image capture device 102 of FIG. 1 in an embodiment in accordance with the invention. Initially, the image capture device captures a video signal and stores the video signal in a memory, as shown in blocks 400 and 402, respectively. A determination is then made at block 404 as to whether or not the video signal is to be optimized. If the video signal will not be optimized, the method passes to block 406 where the non-optimized video signal is transmitted to a display system. The non-optimized video signal may be immediately transferred to a display system, or transmitted sometime later to a display system.

If the video signal will be optimized, selected frames of the image data are analyzed at block 408 and the current and/or subsequent frames are optimized at block 409. The optimized video and metadata are optionally stored in memory at block 410. The optimized video and metadata are transmitted for immediate or later use to the display system at block 406. The metadata includes a flag or indication that the video signal has been optimized pursuant to a known protocol or standard in an embodiment in accordance with the invention. A method for optimizing the frames of image data is described in more detail in conjunction with FIGS. 5-9.

Embodiments in accordance with the invention are not limited to the method shown in FIG. 4. Other embodiments may implement additional or alternate steps, or not perform one or more of the steps shown in FIG. 4. By way of example only, block 402, block 406, or both blocks 402 and 406 are not performed in image capture devices that optimize frames of image data in real-time.

Referring now to FIG. 5, there is shown a flowchart illustrating a method for optimizing a video signal in an embodiment in accordance with the invention. A first frame of image data is analyzed and statistics for that frame are generated at block 500. The analysis of the frame of image data, for example, includes an analysis of one or more RGB channels, or one or more luma and chroma channels, in any combination, in an embodiment in accordance with the invention. Additionally, the statistics can be calculated by analyzing the entire frame of image data or by analyzing defined regions of interest or subframes, or from a reduced resolution version of the image, such as with a paxelized image.

Different types of statistics can be calculated and used in the present invention. For example, the initial statistics include a full bit-depth histogram of the image data, where the full bit-depth is defined as the bit depth of the frame, in one embodiment in accordance with the invention. In another embodiment in accordance with the invention, the initial statistics include a reduced bit-depth histogram, or an overlapping bin histogram. In yet another embodiment in accordance with the invention, the initial statistics include a reduced bit-depth histogram, where the reduced bit-depth is less than the bit depth of the frame, a dark level, a white level, an average code value level (ACVL), or a median code value level (MCVL). A dark level value defines where a given percentage of the histogram falls below a value (x) (e.g., x<25%). A white level defines where a certain percentage of the histogram falls above another value (y) (e.g., y>75%). Different types of initial statistics can be generated in other embodiments in accordance with the invention.

Non-image content, such as block letterbox areas or text areas, may adversely affect the quality of the statistics, and hence the quality of the optimization, in some embodiments in accordance with the invention. In these embodiments, the statistics can be calculated by analyzing defined regions of interest or subframes that do not include regions such as block letterbox or text areas.

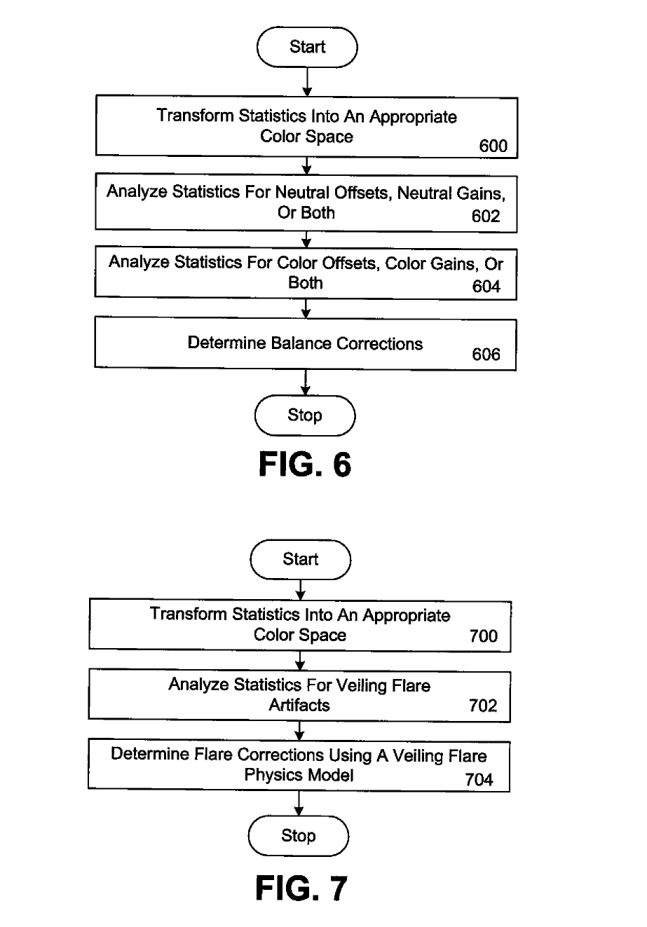

A determination is then made at block 502 as to whether or not balance corrections are to be determined based on the initial statistics. If so, the balance corrections are determined at block 504 and the process continues at block 506. The balance corrections correct for any neutral errors or color balance errors in the frame of image data in an embodiment in accordance with the invention. An exemplary method for determining balance corrections is discussed in greater detail in conjunction with FIG. 6.

A determination is then made at block 506 as to whether or not flare corrections are to be determined using the initial statistics when balance corrections were not previously determined at block 504, or using balance-corrected statistics when the balance corrections are determined at block 504. When flare corrections are to be determined, the flare corrections are determined at block 508 and the process passes to block 510. The flare corrections correct for any veiling flare type of artifacts in the frame of image data in an embodiment in accordance with the invention. Flare corrections also improve image content affected by various video processing or video capture calibration problems, which are unrelated to optical flare phenomena. An exemplary method for determining flare corrections is discussed in greater detail in conjunction with FIG. 7.

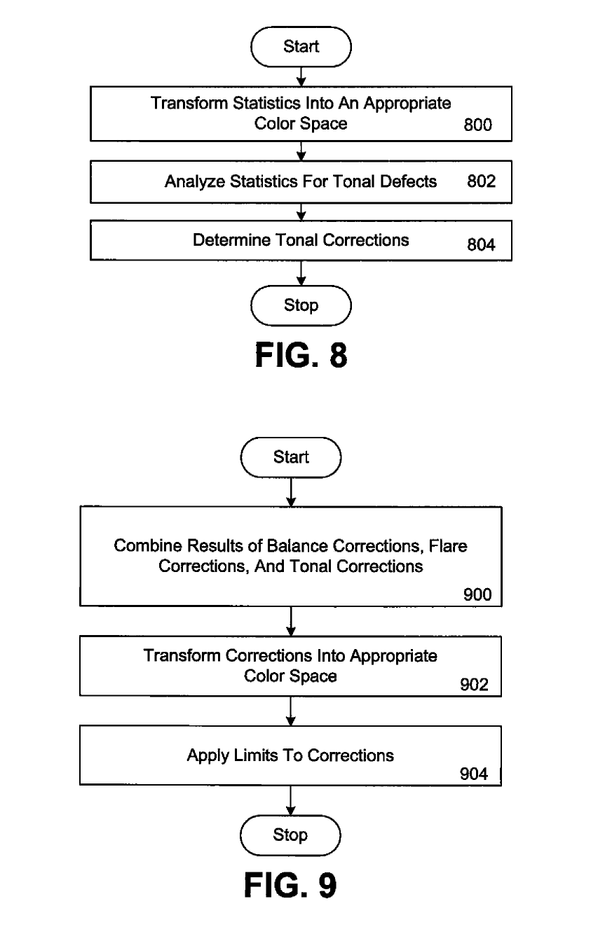

A determination is then made at block 510 as to whether or not tonal corrections are to be determined using the initial statistics, balance-corrected statistics (corrections determined at block 504), flare-corrected statistics (corrections determined at block 508), or balance-corrected and flare-corrected statistics (corrections determined at both blocks 504 and 508). If so, the tonal corrections are determined at block 512 and the process continues at block 514. Tonal corrections correct for any tonal defects in the frame of image data in an embodiment in accordance with the invention. An exemplary method for determining tonal corrections is discussed in greater detail in conjunction with FIG. 8.

The processes described for determining balance corrections, block 502, flare corrections, block 506, and tonal corrections, block 510, can be performed in any order in addition to the order depicted in FIG. 5. Tonal corrections may incorporate the flare corrections or balance corrections or both flare and balance corrections, which would be applied as one tonal correction step.

Next, at block 514, initial corrections are determined using the results of blocks 504, 508 and 512. An exemplary method for determining the initial correction results is discussed in greater detail in conjunction with FIG. 9. When the response to all three blocks 502, 506, and 510 are “no”, the method is in a bypass mode that does not optimize the video signal. The bypass mode also may be selected by a user in an embodiment in accordance with the invention. When the method is in the bypass mode, blocks 514 through 520 may be performed, but would be configured to not have any effect on the video signal in an embodiment in accordance with the invention.

A temporal filter is applied to the initial corrections to generate final corrections, as shown in block 516. In one embodiment in accordance with the invention, the temporal filter is an infinite impulse response filter that is defined by the equation:

Cf,c=kCi,c+(1−k)Cf,p

where Cf,c is the final correction results for the currently analyzed frame, Ci,c is the initial correction results for the currently analyzed frame, Cf,p is the final correction results for the previously analyzed frame, and k ranges from 0.01 to 1.0. In another embodiment in accordance with the invention, Cf,c equals the weighted average of the initial corrections for n previously selected frames, where n is greater than or equal to one, and the initial corrections for the currently selected frame. In another embodiment in accordance with the invention, Cf,c equals the weighted average of the final corrections for m previously selected frames, where m is greater than or equal to two, and the initial corrections for the currently selected frame. In yet another embodiment in accordance with the invention, Cf,c equals the weighted average of the initial corrections for n previously selected frames, where n is greater than or equal to one, of the final corrections for m previously selected frames, where m is greater than or equal to two, and the initial corrections for the currently selected frame.

Next, at block 518, the final corrections are assigned to the image data in one or more frames. The frame or frames may include the currently selected frame as well as any number of subsequent frames in the video signal. Moreover, the final corrections may be assigned to one or more frames that succeed the next selected frame due to timing differences between determining the correction results and applying the final correction results. Thus, the final corrections are assigned to the one or more frames until the final corrections are updated with new final corrections. The final corrections are stored in one or more parameters, including but not limited to gain values, lift values or look-up tables in an embodiment in accordance with the invention.

The final corrections may be stored for later use or may be applied directly in a capture device, such as image capture device 102, or in a display system, such as display system 100.

The final corrections can be applied separately to each pixel in a frame, or to a low frequency blurred version of the image, and then the higher frequency components added back to the corrected low frequency image in one or more embodiments in accordance with the invention. The frequency component images can be directly calculated or used from other algorithmic steps, such as compression or decompression steps.

Finally, the next selected frame is analyzed and the statistics for that frame are generated at block 520. The method then returns to block 502 and repeats blocks 502-520 continuously in an embodiment in accordance with the invention. Other embodiments in accordance with the invention perform the method only once and do not repeat the blocks, or repeat blocks 502-520 for a given amount of time or a given number frames. Other embodiments in accordance with the invention determine the corrections listed in blocks 502-512 in any order or combination.

FIG. 6 is a flowchart depicting a method for determining balance corrections in an embodiment in accordance with the invention. Initially, the statistics may be transformed into an appropriate color space for balance analysis (block 600). The appropriate color space includes, but is not limited by, a wide gamut scene color space in an embodiment in accordance with the invention. One example of a color space is the Extended Reference Input Medium Metric, or ERIMM. ERIMM is described in a book entitled “Colour Engineering: Achieving Device Independent Colour,” edited Phil Green and Lindsay MacDonald and published by John Wiley and Sons (2002) (ISBN: 0471486884). Color spaces other than ERIMM also can be used in other embodiments in accordance with the invention.

Next, the statistics are analyzed for neutral offsets, neutral gains, or both neutral offsets and gains, as shown in block 602. The statistics are also analyzed for color offsets, color gains, or both color offsets and gains at block 604. The balance corrections are then determined at block 606. The balance corrections are stored as parameters, including but not limited to gain values, lift values or look-up tables in one embodiment in accordance with the invention.

One example of a balance analysis involves comparing the ACVL value to an aim value. The difference between these two values is then added to all pixel code values in the frame. Alternatively, a gain value is changed to drive the ACVL value towards the aim value. Another example of a balance analysis involves identifying key features in the frame, such as flesh tones, faces, foliage, sky, etc. and then adjusting balance to create pleasing results.

Referring now to FIG. 7, there is shown a flowchart illustrating a method for performing flare correction in an embodiment in accordance with the invention. Initially, the statistics may be transformed into an appropriate color space for flare analysis (block 700). The statistics may also be adjusted for any previous correction steps, such as the balance correction shown in FIG. 5. The statistics are analyzed for veiling flare artifacts, as shown in block 702. The flare corrections are then determined at block 704 using a veiling flare physics model. The flare corrections are stored as parameters, including but not limited to gain values, lift values or in a look-up table in one embodiment in accordance with the invention.

U.S. Pat. No. 6,912,321 by Gindele, which is incorporated by reference in its entirety herein, discloses a veiling flare physics model that can be used to determine the flare corrections in an embodiment in accordance with the invention. The flare physics model in U.S. Pat. No. 6,912,321 is used to analyze the selected frames in the video signal for veiling flare type of artifacts, which often cause increases in the minimum black code values. In addition to correcting for optical flare and atmospheric haze that occur during image capture, the flare physics algorithm in U.S. Pat. No. 6,912,321 provides a pleasing correction for other video artifacts, including elevated signal levels due to improper video pre-processing (such as improper conversion of studio RGB to REC709 color spaces), and incorrect video capture dark level compensation.

FIG. 8 is a flowchart depicting a method for performing tonal correction on selected frames of image data in an embodiment in accordance with the invention. Initially, the statistics may be transformed into an appropriate color space for tonal analysis (block 800). The statistics may also be adjusted for any previous correction steps, such as the balance correction or flare correction shown in FIG. 5. The statistics are then analyzed for tonal defects, as shown in block 802. Examples of tonal defects include, but are not limited to, dark shadows lacking detail, light highlights lacking detail, and overall contrast that is too high or too low.

The tonal corrections are then determined at block 804. The correction methods include one or more of the following methods in an embodiment in accordance with the invention: (a) selective highlight and shadow tone scale improvements, such as the method described in U.S. Pat. No. 7,158,686 B2 by Gindele, which is incorporated by reference in its entirety herein; (b) histogram normalization adjustment methods, such as the method described in U.S. Pat. No. 6,717,698 B1 by Lee (which is incorporated by reference in its entirety herein); (c) spatial frequency analysis method for making tone scale improvements, such as the method described in U.S. Pat. No. 6,167,165 by Gallagher et al., the method described in U.S. Pat. No. 6,317,521 by Gallagher et al., or the method described in U.S. Pat. No. 6,937,775 by Gindele et al (all three of which are incorporated by reference in their entireties herein); (d) histogram decomposition methods, such as the method described in U.S. Pat. No. 7,245,781 by Gallagher et al. (which is incorporated by reference in its entirety herein); (e) tonal and spatial enhancement methods, such as the method described in U.S. Pat. No. 7,058,234 by Gindele et al. (which is incorporated by reference in its entirety herein); or (f) one or more parameterized models based upon the statistics, the balance-corrected statistics, the flare-corrected statistics, or the balance-corrected and flare-corrected statistics that create improved highlight and shadow tone scale improvements. The tonal corrections are stored as parameters, including but not limited to gain values, lift values or in a look-up table in one embodiment in accordance with the invention.

Referring now to FIG. 9, there is shown a flowchart illustrating a method for determining the initial correction results in an embodiment in accordance with the invention. Initially, one or more corrections are combined to generate an overall correction (block 900). Thus, the balance corrections, the flare corrections, and/or the tonal corrections are combined. The overall correction is transformed into an appropriate color space at block 902. This color space could be the original video color space, or an appropriate output color space. At block 904, the results of these corrections may be limited to reduce artifacts, such as clipping, contouring, excessive noise or excessive contrast, which can commonly result from inappropriate corrections. Upper limits and lower limits may be applied to the corrections in an embodiment in accordance with the invention.

The initial corrections are stored as parameters, including but not limited to gain values, lift values or one or more look-up tables having a bit depth up to the full bit-depth of the image frames in an embodiment in accordance with the invention. The one or more look-up tables have a piecewise slope limited to between 0.5 and 2.0 in one embodiment in accordance with the invention. In other embodiments in accordance with the invention, the one or more look-up tables have a piecewise slope limited to between 0.25 and 4.0.

The invention has been described in detail with particular reference to certain preferred embodiments thereof, but it will be understood that variations and modifications can be effected within the spirit and scope of the invention. For example, embodiments in accordance with the invention are not limited to the methods shown in FIGS. 5-9. Other embodiments may implement additional or alternate steps, or not perform one or more of the steps shown in the figures. By way of example only, the balance corrections, flare corrections, and tonal corrections can be combined immediately after each correction is determined, instead of combining all corrections at block 900 of FIG. 9. In another embodiment, each correction can be applied individually to the frame data in blocks 211 or 409.

Additionally, even though specific embodiments of the invention have been described herein, it should be noted that the application is not limited to these embodiments. In particular, any features described with respect to one embodiment may also be used in other embodiments, where compatible. And the features of the different embodiments may be exchanged, where compatible.

### PARTS LIST

100 display system
102 image capture device
104 input device
106 processor
108 memory
110 communications port
112 display
200-212 block
300 imaging stage
302 image sensor
304 processor
306 memory
308 display
310 output device
312 communications port
400-410 block
500-520 block
600-606 block
700-704 block
800-804 block
900-904 block

1. A processor implemented method for determining correction values for a video signal that includes a plurality of frames of image data, the method comprising:
receiving initial statistics determined from image data included in the video signal;
performing one or more correction operations on the initial statistics to generate initial correction values; and
applying a temporal filter to the initial correction values to generate final correction values.

2. The method of claim 1, further comprising analyzing at least a portion of a frame of image data to generate the initial statistics.

3. The method of claim 1, further comprising analyzing at least a portion of a reduced resolution frame of image data to generate the initial statistics.

4. The method of claim 1, further comprising analyzing at least a portion of two or more frames of image data to generate the initial statistics.

5. The method of claim 4, further comprising repeating for a given number of times:
receiving initial statistics determined from image data included in the two or more frames;
performing one or more correction operations on the initial statistics to generate initial correction values; and
applying a temporal filter to the initial correction values to generate final correction values.

6. The method of claim 1, further comprising repeating for a given number of times:
receiving initial statistics determined from the image data;
performing one or more correction operations on the initial statistics to generate initial correction values; and
applying a temporal filter to the initial correction values to generate final correction values.

7. The method of claim 1, further comprising generating optimized image data by applying the final correction values to image data in one or more frames.

8. The method of claim 7, further comprising storing the optimized image data in a memory.

9. The method of claim 8, further comprising:
generating metadata for the optimized image data; and
storing the metadata with the optimized image data.

10. The method of claim 1, wherein applying a temporal filter to the initial correction values to generate final correction values comprises applying an infinite impulse response filter to the initial correction values to generate final correction values.

11. The method of claim 1, wherein performing one or more correction operations on the initial statistics to generate initial correction values comprises performing a balance correction operation on the initial statistics to generate initial correction values.

12. The method of claim 11, wherein performing a balance correction operation on the initial statistics to generate initial correction values comprises:
analyzing the initial statistics for neutral offsets, neutral gains, or both neutral offsets and gains;
analyzing the initial statistics for color offsets, color gains, or both color offsets and gains; and
determining balance corrections to generate initial corrections.

13. The method of claim 12, further comprising transforming the initial statistics into a color space prior to analyzing the initial statistics.

14. The method of claim 1, wherein performing one or more correction operations on the initial statistics to generate initial correction values comprises performing a flare correction operation on the initial statistics to generate initial correction values.

15. The method of claim 14, wherein performing a flare correction operation on the initial statistics to generate initial correction values comprises:
analyzing the initial statistics for veiling flare artifacts; and
determining flare corrections to generate initial corrections.

16. The method of claim 15, further comprising transforming the initial statistics into a color space prior to analyzing the initial statistics for veiling flare artifacts.

17. The method of claim 1, wherein performing one or more correction operations on the initial statistics to generate initial correction values comprises performing a tonal correction operation on the initial statistics to generate initial correction values.

18. The method of claim 17, wherein performing a balance correction operation on the initial statistics to generate initial correction values comprises:
analyzing the initial statistics for tonal defects; and
determining tonal corrections to generate initial corrections.

19. The method of claim 18, further comprising transforming the initial statistics into a color space prior to analyzing the initial statistics for tonal defects.

20. The method of claim 1, wherein performing one or more correction operations on the initial statistics to generate initial correction values comprises performing at least two correction operations comprised of a balance correction operation, flare correction operation, and a tonal correction operation, on the initial statistics to generate two or more sets of initial correction values.

21. The method of claim 20, wherein generating the initial correction values comprises:
combining the two or more sets of initial correction values to generate an overall correction values;
transforming the overall correction values into an output color space; and
applying limits to the overall correction values.

22. A computer readable medium having stored therein instructions to execute a method for determining correction values for a video signal that includes a plurality of frames of image data comprising:
receiving initial statistics determined from image data included in the video signal;
performing one or more correction operations on the initial statistics to generate initial correction values; and
applying a temporal filter to the initial correction values to generate final correction values.

23. The computer readable medium of claim 22, further comprising analyzing at least a portion of a frame of image data to generate the initial statistics.

24. The computer readable medium of claim 22, further comprising analyzing at least a portion of a reduced resolution frame of image data to generate the initial statistics.

25. The computer readable medium of claim 22, further comprising analyzing at least a portion of two or more frames of image data to generate the initial statistics.

26. The computer readable medium of claim 25, further comprising repeating for a given number of times:
receiving initial statistics determined from image data included in the two or more frames;
performing one or more correction operations on the initial statistics to generate initial correction values; and
applying a temporal filter to the initial correction values to generate final correction values.

27. The computer readable medium of claim 22, further comprising repeating for a given number of times:
receiving initial statistics determined from the image data;
performing one or more correction operations on the initial statistics to generate initial correction values; and
applying a temporal filter to the initial correction values to generate final correction values.

28. The computer readable medium of claim 22, further comprising generating optimized image data by applying the final correction values to image data in one or more frames.

29. The computer readable medium of claim 28, further comprising storing the optimized image data in a memory.

30. The computer readable medium of claim 29, further comprising:
generating metadata for the optimized image data; and
storing the metadata with the optimized image data.

31. The computer readable medium of claim 22, wherein applying a temporal filter to the initial correction values to generate final correction values comprises applying an infinite impulse response filter to the initial correction values to generate final correction values.

32. The computer readable medium of claim 22, wherein performing one or more correction operations on the initial statistics to generate initial correction values comprises performing a balance correction operation on the initial statistics to generate initial correction values.

33. The computer readable medium of claim 32, wherein performing a balance correction operation on the initial statistics to generate initial correction values comprises:
analyzing the initial statistics for neutral offsets, neutral gains, or both neutral offsets and gains;
analyzing the initial statistics for color offsets, color gains, or both color offsets and gains; and
determining balance corrections to generate initial corrections.

34. The computer readable medium of claim 33, further comprising transforming the initial statistics into a color space prior to analyzing the initial statistics.

35. The computer readable medium of claim 22, wherein performing one or more correction operations on the initial statistics to generate initial correction values comprises performing a flare correction operation on the initial statistics to generate initial correction values.

36. The computer readable medium of claim 35, wherein performing a flare correction operation on the initial statistics to generate initial correction values comprises:
analyzing the initial statistics for veiling flare artifacts; and
determining flare corrections to generate initial corrections.

37. The computer readable medium of claim 36, further comprising transforming the initial statistics into a color space prior to analyzing the initial statistics for veiling flare artifacts.

38. The computer readable medium of claim 22, wherein performing one or more correction operations on the initial statistics to generate initial correction values comprises performing a tonal correction operation on the initial statistics to generate initial correction values.

39. The computer readable medium of claim 38, wherein performing a balance correction operation on the initial statistics to generate initial correction values comprises:
analyzing the initial statistics for tonal defects; and
determining tonal corrections to generate initial corrections.

40. The computer readable medium of claim 39, further comprising transforming the initial statistics into a color space prior to analyzing the initial statistics for tonal defects.

41. The computer readable medium of claim 22, wherein performing one or more correction operations on the initial statistics to generate initial correction values comprises performing at least two correction operations comprised of a balance correction operation, flare correction operation, and a tonal correction operation, on the initial statistics to generate two or more sets of initial correction values.

42. The computer readable medium of claim 41, wherein generating the initial correction values comprises:
combining the two or more sets of initial correction values to generate an overall correction values;
transforming the overall correction values into an output color space; and
applying limits to the overall correction values.
